(19) United States
(12) Patent Application Publication
(10) Pub. No.: US 2025/0350697 A1
(43) Pub. Date: Nov. 13, 2025

(54) STORAGE MEDIUM STORING PROGRAM FOR SUPPORTING GENERAL-PURPOSE SCANNING SOFTWARE, CONTROL METHOD FOR INFORMATION PROCESSING APPARATUS, AND INFORMATION PROCESSING APPARATUS

(71) Applicant: CANON KABUSHIKI KAISHA, Tokyo (JP)

(72) Inventor: YASUHIRO TAKAHASHI, Chiba (JP)

(21) Appl. No.: 19/200,418

(22) Filed: May 6, 2025

(30) Foreign Application Priority Data
May 13, 2024 (JP) 2024-077775

(51) Int. Cl. H04N 1/00

(52) U.S. Cl. CPC H04N 1/00809; H04N 1/00129; H04N 1/00811

(57) ABSTRACT

A control method is provided for an information processing apparatus including a program for supporting general-purpose scanning software that is commonly available for use with image processing devices provided by a plurality of manufacturers, the control method including displaying a display screen that accepts a document orientation setting value on a display unit by executing an application program that supports the program, and issuing a scan instruction to an image processing device based on the setting value accepted on the display screen.

### BACKGROUND

### Field

The present disclosure relates to a storage medium storing a program for supporting general-purpose scanning software, a control method for an information processing apparatus, and an information processing apparatus

### Description of the Related Art

There is a known configuration of control software for scanning devices in which a scan instruction is provided to a scanning device connected to a host computer using a scan driver installed in the host computer. An operating system (OS), which serves as the basic software, is installed in the host computer. The scan driver is configured according to the specifications defined by the OS and operates when invoked by the OS. The vendor that provides the scanning device provides a scan driver conforming to the specifications of the OS, thereby providing a means for instructing the scanning device to scan using the OS.

Windows® has recently provided a standard class driver (hereinafter also referred to as “standard driver”) that can be commonly used with scanning devices provided by multiple vendors. Such a standard driver is packed in the OS package and can easily be used by connecting any scanning device to the host computer. This eliminates the need for separately installing a device-specific scan driver suitable for the scanning device, which enhances the convenience. The standard driver may be configured to allow scanning functions to be specified based on scanning function information generated from information obtained from the connected scanning device. This enables users of the standard driver to specify scanning functions according to the capabilities of the connected scanning device, even though the users are using a single standard driver. However, this is limited to functions that can be implemented only by the standard driver, and therefore, the users cannot specify scanner-vendor-specific functions.

Japanese Patent Laid-Open No. 2021-033526 discloses a program for extending the printing function of general-purpose software.

One example of the scanner-vendor-specific-functions is a document-orientation setting function. The document-orientation setting function is a function that allows the user to specify the orientation of the document to be scanned by the scanning device. Examples of the setting include placing a document on the platen glass with the top edge at the back or with the top edge on the side (left). This setting allows the user to obtain image data in an orientation corresponding to the document orientation set by the user.

However, the standard driver is not configured to use the document-orientation setting function, and therefore the user cannot obtain image data in the correct orientation with the top edge of the document at the top.

### SUMMARY

In an aspect of the present disclosure, a non-transitory computer-readable storage medium is provided which stores a program for supporting general-purpose scanning software that is commonly available for use with image processing devices provided by a plurality of manufacturers, the program causing a computer of an information processing apparatus to execute a method including displaying a display screen that accepts a document orientation setting value on a display unit, and issuing a scan instruction to an image processing device based on the setting value accepted on the display screen.

Further features of the present disclosure will become apparent from the following description of exemplary embodiments with reference to the attached drawings.

### BRIEF DESCRIPTION OF THE DRAWINGS

FIG. 1 is a block diagram illustrating the hardware configuration of a scanning system according to the embodiment.

FIGS. 2A and 2B are diagrams illustrating the software configuration of a scanning system according to the embodiment.

FIG. 3A is a diagram illustrating a scan-settings screen displayed by a scanning application according to a first embodiment.

FIGS. 3B and 3C are diagrams illustrating an advanced-settings screen according to the first embodiment.

FIG. 4 is a flowchart of a scanning-function-information editing process performed by an extension application according to the first embodiment.

FIG. 5 shows lists of scanning functions supported by the individual units according to the first embodiment.

FIG. 6 is a sequence chart illustrating a scanning operation according to the first embodiment.

FIG. 7 is a flowchart of a scanning process performed by the extension application according to the first embodiment.

FIG. 8 is a flowchart of a scanning process performed by a scanning device according to the first embodiment.

FIGS. 9A to 9D are diagrams illustrating the operation of the image processing unit of the scanning device according to the first embodiment.

FIG. 10 is a diagram illustrating an advanced-scan-settings screen displayed when the configuration includes the extension application according to a second embodiment.

FIG. 11 shows lists of scanning functions supported by the individual units according to the second embodiment.

FIG. 12 is a diagram illustrating the operation of the image processing unit of the scanning device according to the second embodiment.

FIG. 13 is a diagram illustrating an advanced-scan-settings screen displayed when the configuration includes the extension application according to a third embodiment.

FIG. 14 shows lists of scanning functions supported by the individual units according to the third embodiment.

FIGS. 15A and 15B are diagrams illustrating the operation of the image processing unit of the scanning device according to the third embodiment.

FIG. 16 shows lists of scanning functions supported by the individual units according to a fourth embodiment.

FIG. 17 is a diagram illustrating an advanced-scan-settings screen displayed when the configuration includes the extension application according to a fourth embodiment.

FIG. 18 is a sequence chart illustrating a scanning operation according to the fourth embodiment.

FIG. 19 is a flowchart of a scanning process performed by the extension application according to the fourth embodiment.

### DESCRIPTION OF THE EMBODIMENTS

Embodiments of the present disclosure will be described hereinbelow with reference to the accompanying drawings. It is to be understood that the following embodiments do not limit the present disclosure according to the claims and that not all of the combinations described in the embodiments are required for the solution of the present disclosure.

### First Embodiment

### Hardware Configuration of Scanning System

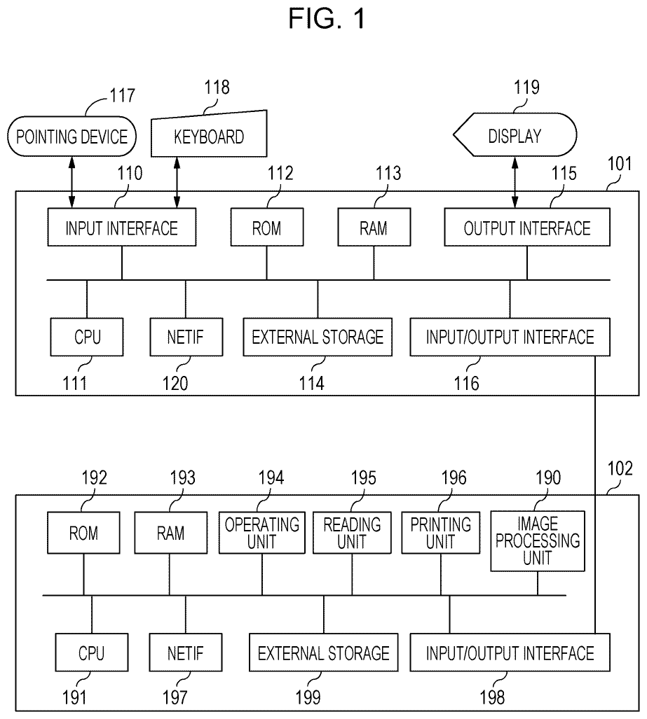

FIG. 1 is a block diagram illustrating the hardware configuration of a scanning system.

### Host Computer

A host computer 101, which is an example of an information processing apparatus, includes an input interface 110, a central processing unit (CPU) 111, a read only memory (ROM) 112, a random-access memory (RAM) 113, an external storage 114, an output interface 115, an input/output interface 116, and a network interface (NETIF) 120. They are connected with a common bus, through which information can be exchanged. The input interface 110 connects to input devices including a keyboard 118 and a pointing device 117. The output interface 115 connects to a display device such as a display 119.

The NETIF 120 performs control for transferring data to/from an external device via a network.

The ROM 112 stores initialization programs.

The RAM 113 is used as a work memory or the like in executing various programs stored in the external storage 114 to allow the various programs to operate in the host computer 101.

Examples of the external storage 114 include a hard disk drive (HDD) and a solid-state drive (SSD). The external storage 114 stores application programs, an operating system (OS), and various items of data.

In this embodiment, the CPU 111 executes processes according to the codes of the programs stored in the ROM 112 to implement the functions of the host computer 101 and the processes of the flowcharts, described below.

### Scanning Device

A scanning device 102, which is an example of an image forming apparatus, is connected to the host computer 101 via an input/output interface 198 of the scanning device 102 and the input/output interface 116 of the host computer 101. The input/output interface 198 of the scanning device 102 and the input/output interface 116 of the host computer 101 may be connected via a wired or wireless network.

The scanning device 102 includes a CPU 191, a ROM 192, a RAM 193, an operating unit 194, a reading unit 195, a printing unit 196, a NETIF 197, an input/output interface 198, an external storage 199, and an image processing unit 190.

The CPU 191 control the scanning device 102, which is an image forming apparatus, as a whole.

The ROM 192 is a memory that stores programs.

The RAM 193 is a memory that temporarily stores programs and image data.

The operating unit 194 presents the information of the scanning device 102 to the user and allows the user to give direct instructions.

The reading unit 195 is a scanner and reads images of documents.

The printing unit 196 prints images on sheets based on image data. The printing unit 196 is not an absolute necessity.

The NETIF 197 is a network interface that performs control for transferring data to/from an external device via a network.

The image processing unit 190 performs various image editing processes on the input image data.

Here, the host computer 101 and the scanning device 102 are separately configured, but they may be configured as a single information processing apparatus. The scanning-settings screen and the advanced-settings screen, described below, are displayed on the display 119. In this embodiment, the scanning device will be described using an electrophotographic digital multifunction device having multiple functions, such as copying, printing, and faxing, as an example. However, this is illustrative only. This embodiment is also applicable to devices that use an ink-jet method or other processes and scanners that performs only image reading. The host computer 101 may be a desktop personal computer, a smartphone, or a notebook personal computer.

### Software Configuration of Scanning System

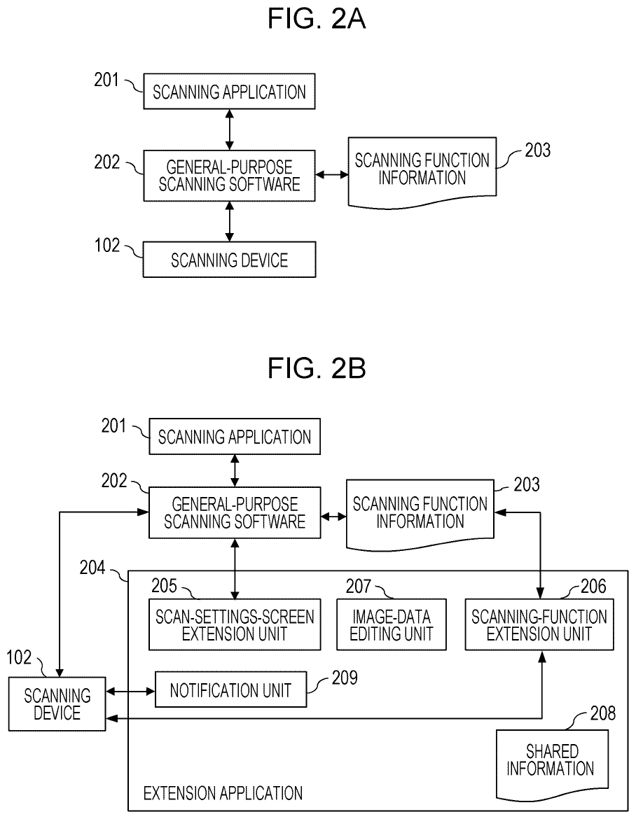

FIGS. 2A and 2B schematically illustrate the software configuration of the scanning system. The software configuration in FIGS. 2A and 2B is stored in the external storage 114 of FIG. 1. Here, the explanation is based on a scanning system that uses the host computer 101 equipped with Microsoft® Windows® 11 as its OS. However, the macOS® of Apple® is also provided with the standard driver, to which this technique can also be applied.

FIG. 2A illustrates a general configuration in which an extension application 204 is not associated with general-purpose scanning software 202 and the scanning device 102.

FIG. 2B illustrates a configuration in which the extension application 204 is associated with the general-purpose scanning software 202 and the scanning device 102. Software Configuration of Scanning System (Extension Application Not Associated)

First, the configuration of a scanning system in which the extension application 204 is not associated will be described with reference to FIG. 2A.

The scanning application 201 is software for importing scanned content (image data). Examples include a document creation application and an image editing application. In response to receiving a scan request from the user, the scanning application 201 issues a scan instruction to the OS. The scan instruction includes scan settings information to specify the operations of the general-purpose scanning software 202 and the scanning device 102.

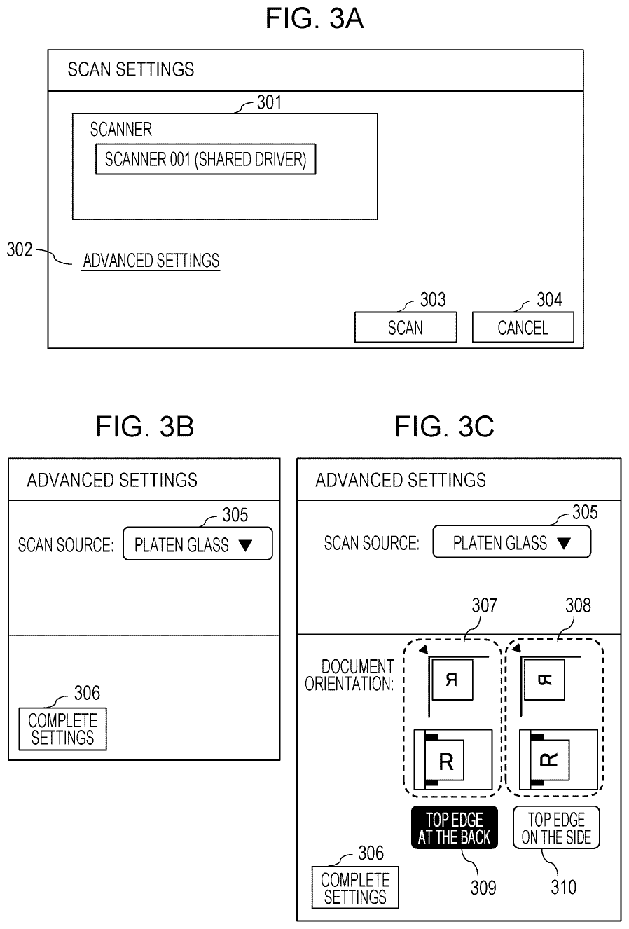

The scanning application 201 can display a scan-settings screen provided by the general-purpose scanning software 202, the OS, or the scanning application 201 to execute the scan instruction. When “advanced settings” control in the scan-settings screen is pressed, the general-purpose scanning software 202 additionally displays an advanced-settings screen. The scan-settings screen and the advanced-settings screen will be described below with reference to FIGS. 3A to 3C. The advanced-settings screen includes setting items indicating configurable scanning functions (hereinafter also referred to as “control items”) and control items indicating their setting values according to the capability information (configurable information) from the general-purpose scanning software 202.

The general-purpose scanning software 202 determines the scan capability based on scanning function information 203.

The scanning function information 203 is data that indicates scanning functions including all configurable scanning functions, their setting values, and the exclusion relationship among the setting values. The scanning function information 203 is included in the configuration file of the general-purpose scanning software 202 and is placed in the external storage 114 as an unchangeable file. Alternatively, the scanning function information 203 may be dynamically generated by the general-purpose scanning software 202. Specifically, the general-purpose scanning software 202 or the OS may be configured to obtain the attribute data of the scanning device from the scanning device 102 and generate the scanning function information 203 according to the attribute information in the obtained attribute data. The scanning function information 203, if dynamically generated, can be edited. The attribute data of the scanning device 102 obtained from the scanning device 102 includes attribute information indicating functions that can be specified by the scanning device 102 (the capability of the scanning device 102) and setting values related to the attribute information. This information is stored in the RAM 113.

This configuration of the general-purpose scanning software 202 allows the user to specify scanning functions commonly available across all the scanning devices 102 according to the connected scanning device 102. In other words, even if a scanning device with different functions or a scanning device developed by a different vendor is connected, the general-purpose scanning software 202 allows the user to specify available scanning functions according to the connected scanning device. The vendor may be translated into the manufacturer of the scanning device 102. Here, the general-purpose scanning software 202 is a standard-class driver for executing scanning operations based on a standard scan protocol called Mopria. The general-purpose scanning software 202 obtains the capability information of the connected scanning device 102 so that the user can specify scanning functions supported by the connected scanning device 102 and generates the scanning function information 203 based on the information. However, the general-purpose scanning software 202 does not support a document-orientation setting function. This is because the document-orientation setting function is a unique function of the scanner vendor (or the scanner manufacturer).

### Software Configuration of Scanning System (Extension Application Associated)

Next, the software configuration of a scanning system in which the extension application 204 is associated will be described with reference to FIG. 2B. Descriptions of the configuration identical to those of FIG. 2A will be omitted.

The extension application 204 is software for extending the functions of the general-purpose scanning software 202 and is not contained (packed) in advance in the OS. For this reason, the user needs to operate the host computer 101 to download the extension application 204 from the server via the Internet and install it. Alternatively, the extension application 204 may be automatically installed in response to connection of the scanning device 102 to the host computer 101. Specifically, when the scanning device 102 is connected to the host computer 101, the OS obtains device identification information from the scanning device 102. The OS may download the extension application 204 corresponding to the obtained device identification information from the server via the Internet and install it. In other words, the general-purpose scanning software 202 and the extension application 204 are stored in the host computer 101 as different files.

The general-purpose scanning software 202 and the extension application 204 may be updated and version-upgraded. These update processes are carried out at separate times. In other words, the timing when the general-purpose scanning software 202 is obtained and the timing when the extension application 204 is obtained by the host computer 101 is obtained are different. The trigger to obtain the general-purpose scanning software 202 and the trigger to obtain the extension application 204 by the host computer 101 are also different. When the extension application 204 is installed, the OS associates the extension application 204 with the general-purpose scanning software 202 and the scanning device 102.

The extension application 204 described in this embodiment includes a scan-settings-screen extension unit 205, a scanning-function extension unit 206, an image-data editing unit 207, and a notification unit 209. The extension application 204 further includes shared information 208 accessible from each unit. The actual form of the shared information 208 is a file stored in the external storage 114 or information stored on the RAM 113. The extension application 204 writes and reads information to/from the shared information 208 by using an application program interface (API) provided by the OS.

The extension application 204 may terminate the operation every time the process of each unit is completed. In that case, the OS starts the extension application 204 every time a request to use each unit is provided.

Furthermore, the extension application 204 may cancel the process of each unit during the process. If the process is cancelled, the job being processed is deleted by the OS.

In response to receiving a scan request from the user, the scanning application 201 issues a scan instruction to the OS. With this configuration as well, the scanning application 201 can display a scan-settings screen, as with the configuration of FIG. 2A. With this configuration, an advanced-settings screen provided by the extension application 204 is displayed. Specifically, an advanced-settings screen provided by the scan-settings-screen extension unit 205 of the extension application 204 is displayed. The scan-settings-screen extension unit 205 can store advanced setting values set by the user in the shared information 208.

The extension application 204 includes the image-data editing unit 207. The image-data editing unit 207 obtains image data from the scanning device 102 and edits the image data. The image-data editing unit 207 obtains advanced settings information from the shared information 208 and edits the image data according to the advanced setting values. The extension application 204 may be configured to obtain image data obtained by the general-purpose scanning software 202 and edit the image data according to the advanced setting values.

The extension application 204 includes the scanning-function extension unit 206. The scanning-function extension unit 206 can edit the scanning function information 203 generated by the general-purpose scanning software 202 or the OS. For this reason, the scanning-function extension unit 206 can add functions provided by the extension application 204. The scanning-function extension unit 206 can also add a function that is supported by the scanning device 102 but is not supported by the general-purpose scanning software 202 (a document-orientation setting function), the exclusion relationship among the setting values of the scanning functions, and so on. When the extension application 204 is first associated with the scanning device 102 and the general-purpose scanning software 202, the OS starts the scanning-function extension unit 206. The OS may start the scanning-function extension unit 206 when the OS is started or at another time.

The extension application 204 further includes the notification unit 209. The notification unit 209 can display a notification to the user in response to the occurrence of an error in the scanning device 102. For example, when a scan jam error occurs in the scanning device 102, the general-purpose scanning software 202 detects it, and the OS causes the display 119 to display a message using a notification function called a toast notification, which is a function of the OS. When the toast notification is pressed by the user, the notification unit 209 of the extension application 204 is invoked by the OS, and the user interface (UI) screen of the notification unit 209 is displayed. On the UI screen of the notification unit 209, for example, a scan jam error detailed message or a jam clear method can be displayed.

The configuration of the extension application 204 for implementing this embodiment is not limited to one that includes all of the above-described functions (units) and may include only some of the functions or additional functions. The extension application 204 may also be simply referred to as scanning software.

The extension application 204 includes at least one of the following functions as described above.

The first is a function to display a settings screen (the scan-settings-screen extension unit 205).

The second is a function to edit image data according to advanced setting values (the image-data editing unit 207).

The third is a function to extend functions that can be specified by image data generating software (the scanning-function extension unit 206).

The fourth is a function to display a screen in response to the occurrence of an error in the scanning device 102 (the notification unit 209).

### Settings Screen

Next, examples of the scan-settings screen and the advanced-settings screen of this embodiment will be described with reference to FIGS. 3A to 3C.

FIG. 3A illustrates a scan-settings screen displayed by the scanning application 201.

FIG. 3B illustrates an advanced-settings screen displayed when the configuration does not include the extension application 204, illustrated in FIG. 2A.

FIG. 3C illustrates an advanced-settings screen displayed when the configuration includes the extension application 204, illustrated in FIG. 2B.

The units or modules for displaying the scan-settings screen are not limited to those described above. For example, the scan-settings-screen extension unit 205 may be configured only to generate a display screen.

In that case, the scan-settings-screen extension unit 205 sends the generated display screen to the scanning application 201 via the general-purpose scanning software 202, and the scanning application 201 may display the obtained display screen.

### Scan-Settings Screen (Scanning Application)

First, the scan-settings screen in FIG. 3A displayed by the scanning application 201 will be described.

A control 301 includes objects that prompt the user to set a scanner to be used to scan image data (a scanner to be used for scanning).

A control 303 is a scan start button. A control 304 is a scan cancel button.

A control 302 is an advanced settings button. When the control 302 is pressed, an additional scan screen is displayed by the general-purpose scanning software 202 or the scan-settings-screen extension unit 205.

### Advanced-Settings Screen (General-Purpose Scanning Software)

Second, FIG. 3B will be described. FIG. 3B illustrates an additional settings screen displayed by the general-purpose scanning software 202 when the extension application 204 is not included.

A control 305 allows the scan source to be selected and indicates that “Platen glass” is selected.

A control 306 is a settings completion button. When the control 306 is pressed, the screen returns to the scan-settings screen illustrated in FIG. 3A.

### Advanced-Settings Screen (Extension Application)

Next, FIG. 3C will be described. FIG. 3C illustrates an additional settings screen displayed by the scan-settings-screen extension unit 205 when the extension application 204 is included. Unlike FIG. 3B, controls 309 and 310 are added.

The controls 309 and 310 are buttons for setting the orientation of the document placed on the reading unit 195.

Images 307 and 308 show images of documents placed on the reading unit 195 with the top edge at the back and the top edge on the side, respectively. The upper row shows examples of document placement on the platen glass, and the lower row shows an example of document placement on the feeder (automatic document feeder). In the example of document placement on the platen glass, the reversal of the letter R indicates that the document is placed, with the printed side facing downward.

FIG. 3C shows a placement example when the document is placed on the platen glass, with the top edge at the back. The user can obtain image data in the correct orientation, with the top edge at the top, by setting the control 309 or 310 according to the document orientation set by the user.

The reason why the scan setting items differ between FIG. 3B and FIG. 3C will be described. The advanced-settings screen is generated with reference to scan capability generated based on the scanning function information 203. However, since the general-purpose scanning software 202 does not support the document-orientation setting function, the document-orientation setting function cannot be added to the scanning function information 203. Even if the scanning function information 203 originally includes the document-orientation setting function, the general-purpose scanning software 202 cannot interpret the document-orientation setting function included in the scanning function information 203, and therefore, the document-orientation setting function cannot be displayed on the advanced-settings screen. However, the scanning-function extension unit 206 may add the document-orientation setting function to the scanning function information 203, and the scan-settings-screen extension unit 205 may display the advanced-settings screen with reference to the scan capability. This configuration allows the extension application 204 to display the document-orientation setting function on the advanced-settings screen. FIG. 3C may additionally include extended functions other than the document-orientation setting function.

### Scanning-Function-Information Editing Process (Scanning-Function Extension Unit)

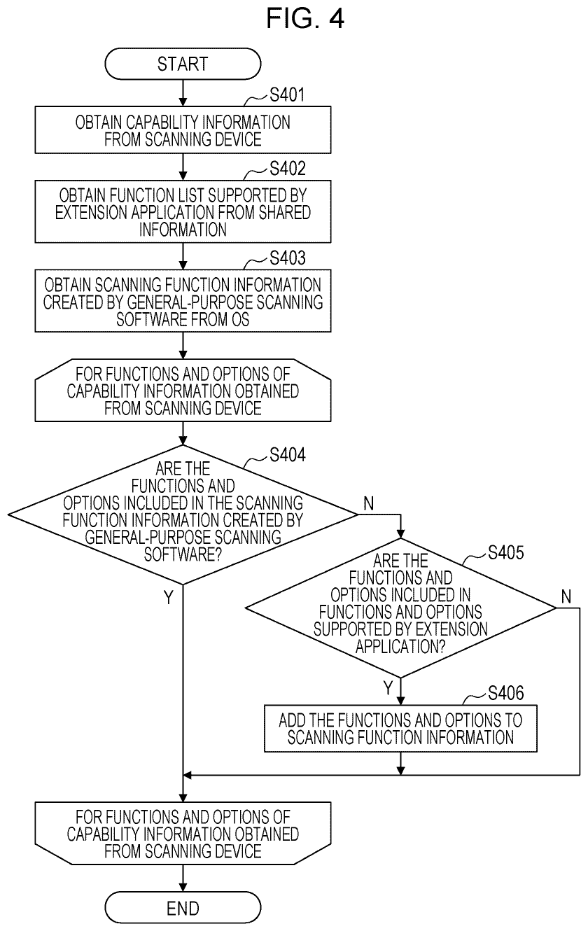

Referring next to FIG. 4, a processing procedure for the scanning-function extension unit 206 to edit the scanning function information 203 will be described. The individual steps are carried out by the CPU 111 executing the units that are read from the external storage 114 into the RAM 113.

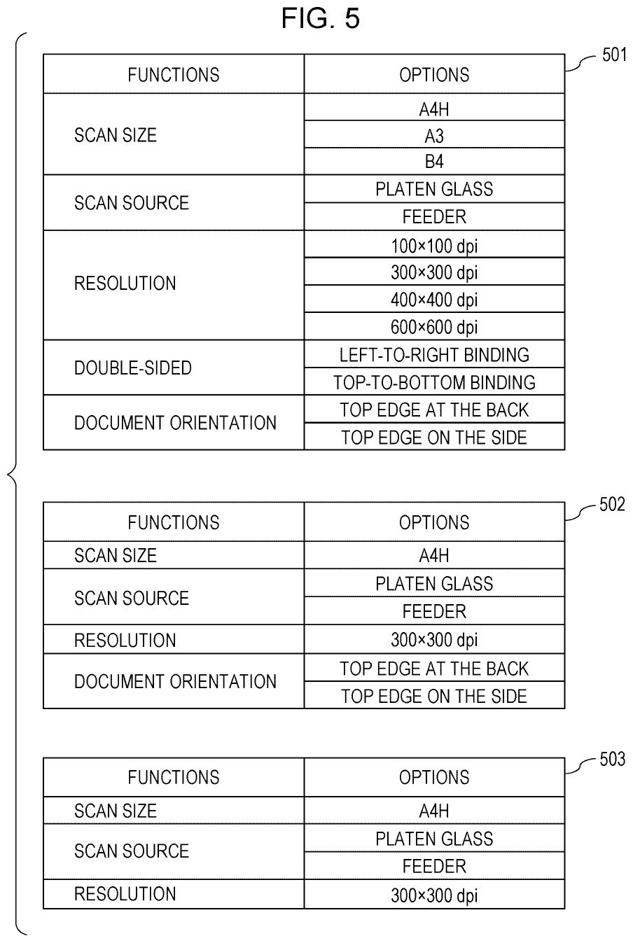

First, in S401, first, the scanning-function extension unit 206 obtains capability information from the scanning device 102. The capability information includes attribute information indicating the functions that can be specified in the scanning device 102 and setting values related to the attribute information. List 501 in FIG. 5 shows examples of scanning functions obtained from the scanning device 102. As shown in the list 501, scan size selection and other functions and settable options for the functions can be obtained from the scanning device 102.

Second, in S402, the scanning-function extension unit 206 obtains a list of scanning functions supported by the extension application 204 from the shared information 208. The list of scanning functions supported by the extension application 204 is stored in the shared information 208 and includes all scanning functions that can be processed by the extension application 204 and their setting values. A list 502 in FIG. 5 shows examples of scanning functions supported by the extension application 204. The list of scanning functions supported by the extension application 204 may be updated by updating the extension application 204.

Next, in S403, the scanning-function extension unit 206 obtains the scanning function information 203 created by the general-purpose scanning software 202 from the OS. A list 503 in FIG. 5 shows examples of scanning functions supported by the general-purpose scanning software 202. The scanning function information 203 created by the general-purpose scanning software 202 is based on the scanning functions (list 501) obtained by the general-purpose scanning software 202 from the scanning device 102. The scanning function information 203 created by the general-purpose scanning software 202 includes, among the scanning functions obtained from the scanning device 102, only the scanning functions supported by the general-purpose scanning software 202. For this reason, the functions in the scanning function information 203 are limited. For example, the scanning functions 501 obtained from the scanning device 102 includes the document-orientation setting function, whereas the general-purpose scanning software 202 does not support the document-orientation setting function, and the scanning function information 203 does not include the document-orientation setting function. By adding functions and options to the scanning function information 203 through the scanning-function extension unit 206, the extension application 204 can compensate for the functional limitations of the general-purpose scanning software 202. The scanning-function extension unit 206 can also delete unnecessary functions and options from the scanning function information 203 created by the general-purpose scanning software 202.

The following steps S404, S405, and S406 are repeated for the list of scanning functions obtained from the scanning device 102 in S401. In this embodiment, the processes are repeated for the 13 options included in the list 501, Scan Size: A4H to Document Orientation: Top Edge on the Side.

First, in S404, the scanning-function extension unit 206 determines whether the functions and options being processed are included in the scanning function information 203 created by the general-purpose scanning software 202. If the functions and options being processed are included in the scanning function information 203 (Yes in S404), the process returns to the beginning of the repetition loop. Specifically, the scanning-function extension unit 206 selects the next item from the functions and options of the scanning functions obtained from the scanning device 102 and performs S404 again. If the last item of the functions and options of the scanning functions obtained from the scanning device 102 is being processed, the process exits from the loop and terminates the flowchart of FIG. 4. In contrast, if the function and option being processed are not included in the scanning function information 203 (No in S404), the process proceeds to S405. In this embodiment, for example, Scan Source: Platen Glass in the list 501 of the scanning functions of the scanning device 102 is included also in the list 503, which is the scanning functions of the general-purpose scanning software 202, and therefore, it is determined in S404 as Yes. In contrast, Document Orientation: Top Edge at the Back in the list 501 is not included in the list 503, and therefore, it is determined in S404 as No, and the process proceeds to S405.

Next, in S405, the scanning-function extension unit 206 determines whether the functions and options being processed are included in the functions and options supported by the extension application 204. If it is determined that the functions and options being processed are included (Yes in S405), the process proceeds to S406. In contrast, if no functions and options being processed are included (No at S405), the CPU 111 performs S404 again or exits from the loop and terminates the processing of the flowchart as when it is determined as Yes in S404. In this embodiment, for example, if the function being processed is “Document orientation: Top edge at the back”, the function is included also in the list 502, which is the scanning functions of the extension application 204, and therefore, it is determined as Yes in S405, and the process proceeds to $406.

In S406, the scanning-function extension unit 206 adds the function and option being processed to the scanning function information 203. After completion of the process of S406, the CPU 111 performs S404 again or exits from the loop and terminates the processing of the flowchart, just as when it is determined as Yes in S404.

Thus, the scanning-function extension unit 206 adds the functions and options that are not supported by the general-purpose scanning software 202 but are supported by the scanning device 102 and the extension application 204 to the scanning function information 203. Scan capability is generated based on the scanning function information 203 edited through this processing. Furthermore, the scan-settings-screen extension unit 205 can extend functions that are not supported by the general-purpose scanning software 202 and display the advanced-settings screen illustrated in FIG. 3C by generating a display screen based on the generated scan capability.

### Sequence of Scanning Process

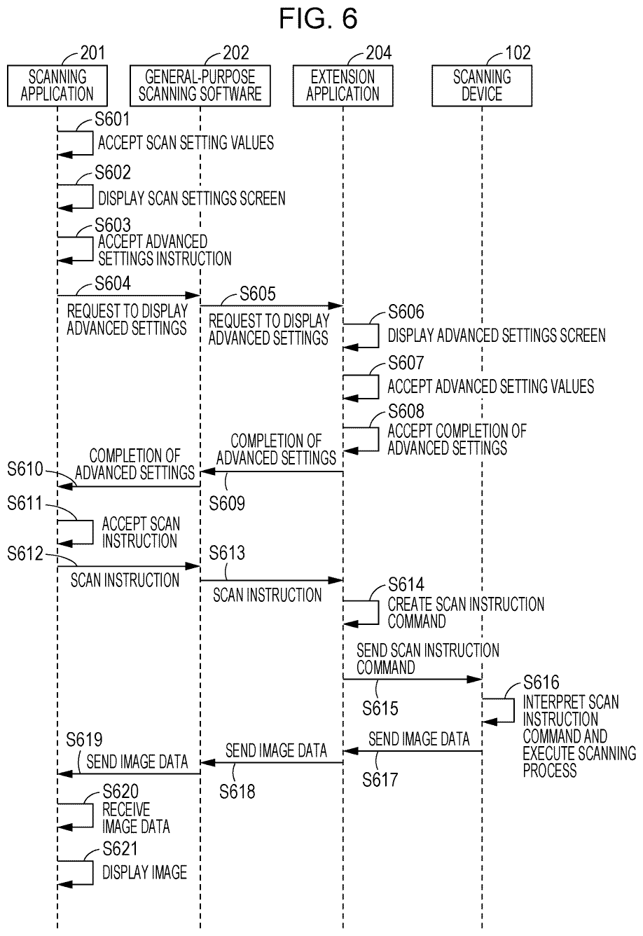

Referring next to FIG. 6, the process sequence performed by the scanning application 201, the general-purpose scanning software 202, the extension application 204, and the scanning device 102 after the scanning application 201 accepts scan setting values will be described. The steps other than those of the scanning device 102 in FIG. 6 are performed by the CPU 111 reading the scanning application 201, the general-purpose scanning software 202, and the extension application 204 from the external storage 114 into the RAM 113 and executing them. The steps of the scanning device 102 in FIG. 6 are implemented by the CPU 191 of the scanning device 102 reading the programs stored in the ROM 192 or the external storage 199 into the RAM 193 and executing them.

In S601, the scanning application 201 accepts scan setting values from the user.

The user can instruct the scanning application 201 to configure scan setting values by operating the pointing device 117 or the keyboard 118.

In S602, the scanning application 201 displays the scan-settings screen illustrated in FIG. 3A on the display 119.

In S603, the scanning application 201 accepts an advanced settings instruction from the user.

The user can provide the advanced setting values instruction by operating the pointing device 117 or the keyboard 118 to select the control 302.

In S604, the scanning application 201 requests the general-purpose scanning software 202 to display advanced setting values.

In S605, the general-purpose scanning software 202 requests the extension application 204 to display the advanced setting values. In the case of the configuration of FIG. 2B, the general-purpose scanning software 202 displays the advanced-settings screen of FIG. 3C, as described above.

In S606, the scan-settings-screen extension unit 205 of the extension application 204 displays the advanced-settings screen of FIG. 3C on the display 119. This is because the document-orientation setting function is added to the scanning function information 203 by the scanning-function extension unit 206 as illustrated in FIG. 4. The scan-settings-screen extension unit 205 displays the advanced-settings screen of FIG. 3C on the display 119 with reference to the scan capability generated based on the scanning function information 203 after the addition. In this embodiment, since the scan size supported by the extension application 204 is limited to a single type, A4H, there is no need for the user to make a selection, and the scan size is not displayed on the advanced-settings screen. Since the resolution is also limited to a single type, 300×300 dpi, the resolution is not displayed on the advanced-settings screen. Even such unchangeable items may be displayed on the advanced-settings screen for the user.

In S607, the scan-settings-screen extension unit 205 accepts the advanced setting values. In this embodiment, “Scan source: Platen glass” and “Document orientation: Top edge at the back” are selected by the user, as illustrated in FIG. 3C. The accepted setting values are stored in the RAM 113 by the CPU 111.

In S608, the scan-settings-screen extension unit 205 accepts completion of the advanced settings and instructs the CPU 111 to write the accepted setting values into the scan settings information. The user can provide an instruction to terminate the advanced settings by operating the pointing device 117 or the keyboard 118 to select the control 306. Items that are not selected by the user, such as the resolution, may be written together to the scan settings information.

In S609, the extension application 204 sends the completion of the advanced settings to the general-purpose scanning software 202.

In S610, the general-purpose scanning software 202 sends the completion of the advanced settings to the scanning application 201.

In S611, the scanning application 201 accepts a scan instruction from the user. The user can provide the scan instruction by selecting the control 303 with the pointing device 117 or the keyboard 118.

In S612, the scanning application 201 sends the scan instruction to the general-purpose scanning software 202.

In S613, the general-purpose scanning software 202 sends the scan instruction to the extension application 204.

Next, in S614, the extension application 204 creates a scan instruction command based on the scan settings information written in S608. If in S608 items that are not selected by the user, such as resolution, are not written to the scan settings information, the extension application 204 may add the setting values when creating the scan instruction command in S614. Alternatively, the scanning device 102 may operate with its default value instead of adding the setting values.

Next, in S615, the extension application 204 sends the scan instruction command to the scanning device 102 to execute a scan.

In S616, the scanning device 102 interprets the scan instruction command and executes a scan.

The scanning device 102 executes necessary image processing on the image data according to the scan instruction during execution of the scan.

In this embodiment, when the scan settings illustrated in FIG. 3C have been configured, the image data obtained by the scan is rotated so as to be positioned in correct orientation on the PC according to the document orientation setting.

In S617, the scanning device 102 sends the generated image data to the extension application 204.

In S618, the extension application 204 sends the received image data to the general-purpose scanning software 202.

In S619, the general-purpose scanning software 202 sends the received image data to the scanning application 201.

In S620, the scanning application 201 receives the image data.

In S621, the scanning application 201 displays the received image data, and the sequence of this scanning process is completed.

### Scanning Process (Extension Application)

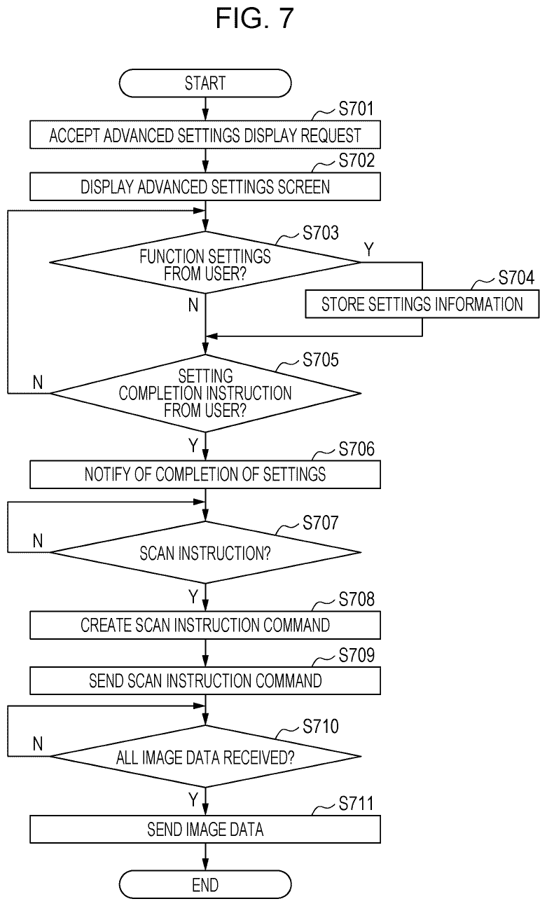

Next, the procedure of the scanning process executed by the extension application 204 will be described with reference to FIG. 7. The steps are implemented by the CPU 111 executing the units read from the external storage 114 into the RAM 113.

In S701, the extension application 204 accepts a request to display advanced setting values.

In S702, the scan-settings-screen extension unit 205 of the extension application 204 displays the advanced-settings screen of FIG. 3C on the display 119. This is because the document-orientation setting function is added to the scanning function information 203 by the scanning-function extension unit 206 as illustrated in FIG. 4. The scan-settings-screen extension unit 205 displays the advanced-settings screen of FIG. 3C on the display 119 with reference to the scanning function list 502 generated based on the scanning functions after the addition.

In S703, the scan-settings-screen extension unit 205 determines whether any functions have been configured by the user. If some functions have been configured by the user (Yes in S703), the CPU 111 proceeds to S704; otherwise (No in S703), the CPU 111 proceeds to S705.

In S704, the extension application 204 accepts the advanced setting values, and the CPU 111 stores the accepted setting values in the RAM 113 and proceeds to S705.

In S705, the scan-settings-screen extension unit 205 determines whether a setting completion instruction has been provided by the user. If a setting completion instruction has been provided (Yes in S705), the CPU 111 accepts the completion of the advanced settings, writes the accepted setting values to the scan settings information, and proceeds to S706; otherwise (No in S705), the process returns to S703, where it is determined again whether any functions have been configured by the user.

In S706, the extension application 204 sends the completion of the advanced settings to the general-purpose scanning software 202.

In S707, the extension application 204 determines whether a scan instruction has been provided by the general-purpose scanning software 202. If a scan instruction has been provided (Yes in S707), the CPU 111 proceeds to S708; otherwise (No in S707), the process returns to S707, where it is determined again whether a scan instruction has been provided by the general-purpose scanning software 202.

In S708, the extension application 204 creates a scan instruction command based on the scan settings information written in S705.

An example of a method for creating the scan instruction command in S708 is a method in which a standard protocol command is extended. One example of the extension method is to write a dedicated command in the extended area of the standard protocol command. Other examples include a method in which a proprietary command is added to the tail end of the standard protocol command and a method in which the extension application 204 overwrites the standard protocol command with a proprietary command system.

If the instructions are provided by the extension application 204, the instructions and communication may be carried out using a vendor's proprietary protocol without reference to the standard protocol.

In S709, the extension application 204 sends the scan instruction command to the scanning device 102 to execute a scan.

In S710, the extension application 204 determines whether all image data has been received from the scanning device 102. If all image data has been received (Yes in S710), the CPU 111 proceeds to S711; otherwise (No in S710), the process returns to S710, where it is determined whether all image data has been sent from the scanning device 102.

In S711, the extension application 204 sends the received image data to the general-purpose scanning software 202 and terminates the processing procedure.

### Scanning Process (Scanning Device)

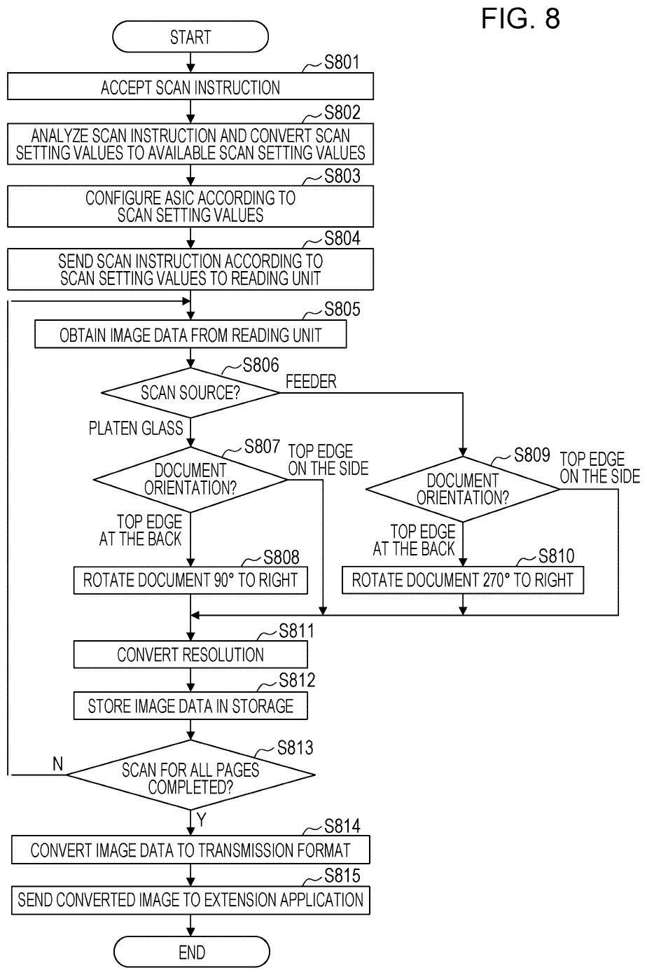

Next, the procedure of the scanning process executed by the scanning device 102, which has received a scan instruction from the extension application 204, will be described with reference to FIG. 8. The steps of the flowchart of FIG. 8 are implemented by the CPU 191 executing the programs stored in the ROM 192.

In S801, the CPU 191 accepts a scan instruction sent from the extension application 204.

In S802, the CPU 191 analyzes the scan instruction command accepted in S801 and converts the scan setting values to scan setting values with which the scanning device 102 can perform the scanning process. In this embodiment, the scan setting values are “Scan source: Platen glass”, “Scan size: A4H”, “Resolution: 300×300 dpi”, and “Document orientation: Top edge at the back”.

In S803, the CPU 191 determines an application specific integrated circuit (ASIC) for the image processing unit 190 to be used to execute the scan according to the scan setting values converted in step S802 and configures the ASIC.

In S804, the CPU 191 sends a scan instruction according to the scan setting values to the reading unit 195. In this embodiment, the CPU 191 sends instructions to perform scanning of A4H-sized paper on the platen glass.

In S805, the CPU 191 obtains image data from the reading unit 195.

In S806, the CPU 191 switches between the next processes according to whether the scan source specified at the control 305 in FIG. 3C is “Platen glass” or “Feeder”. If “Platen glass” is specified, the CPU 191 proceeds to S807. If “Feeder” is specified, the CPU 191 proceeds to S809.

In S807, the CPU 191 switches between the next processes according to whether the document orientation specified in FIG. 3C is “Top edge at the back” 309 or “Top edge on the side” 310. If “Top edge at the back” 309 is specified, the CPU 191 proceeds to S808. If “Top edge on the side” 310 is specified, the CPU 191 proceeds to S811.

In S808, the CPU 191 rotates the image data 90° to the right and proceeds to S811.

In S809 following the case where “Feeder” is specified as the scan source in S806, the CPU 191 switches the rotation angle of the image data obtained from the reading unit 195 according to the specified document orientation. If “Top edge at the back” 309 is specified, the CPU 191 proceeds to S810, and if “Top edge on the side” 310 is specified, the CPU 191 does not rotate the image data and proceeds to S811.

In S810, the CPU 191 rotates the image data obtained from the reading unit 195 270° to the right and proceeds to S811.

### Top Edge at the Back: Platen Glass

The reason the rotation angle differs between the platen glass and the feeder in the “Top edge at the back” 309 setting is that the document scanning directions are different.

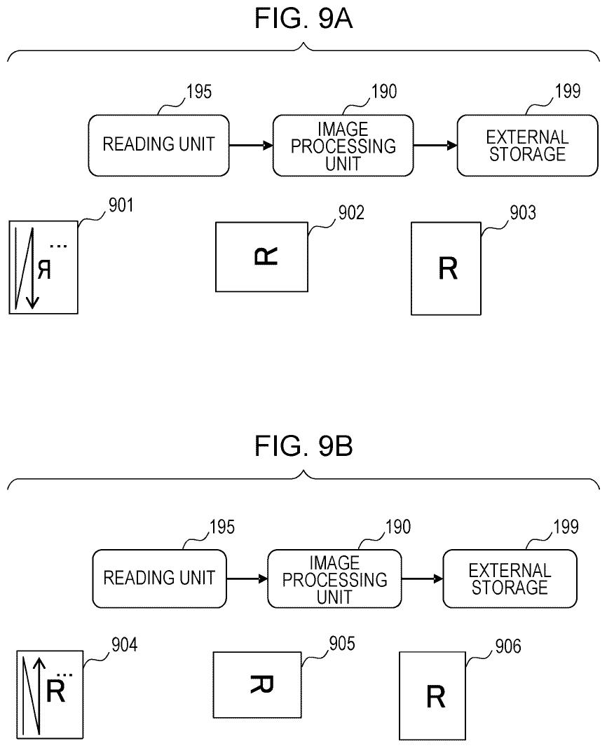

The following description is made with reference to FIGS. 9A and 9B. FIG. 9A is a diagram illustrating that the rotation angle in S808 is 90°.

Reference sign 901 denotes a document placed on the platen glass, with the printed side facing downward. The reversal of the letter R indicates that the printed side is facing downward. The document 901 is scanned by the reading unit 195 from top to bottom as indicated by the arrow and is recorded in the RAM 193 as image data 902. Since the image data 902 obtained from the reading unit 195 is oriented to the left (in the 9 o'clock direction), the image data 902 needs to be rotated 90° to the right by the image processing unit 190 to reach the 0 o'clock direction. The image after the rotation is image data 903, which is oriented correctly, with the top edge of the document at the top.

### Top Edge at the Back: Feeder

FIG. 9B illustrates that the rotation angle in S810 is 270° to the right.

Reference sign 904 denotes a document placed on the platen glass, with the printed side facing upward. The document 904 is scanned by the reading unit 195 from bottom to top as indicated by the arrow and is recorded in the RAM 193 as image data 905. Since the image data 905 obtained from the reading unit 195 is oriented to the right (in the 3 o'clock direction), the image data 905 needs to be rotated 270° to the right by the image processing unit 190 to reach the 0 o'clock direction. The image after the rotation is image data 906, which is oriented correctly, with the top edge of the document at the top.

### Top Edge on the Side: Feeder

FIG. 9C is a diagram illustrating that the rotation angle of the image that is necessary when the document is placed on the platen glass, with the top edge on the side and the printed surface facing downward, is 0°. FIG. 9D is a diagram illustrating that the rotation angle of the image that is necessary when the document is placed on the feeder, with the top edge on the side and the printed surface facing upward, is 0°. In both cases, when the document is placed, with the top edge on the side, image data 908 and 911 obtained from the reading unit 195 is oriented in the 0 o'clock direction, and therefore the rotating process through the image processing unit 190 is not needed.

Referring back to FIG. 8, in S811, the image processing unit 190 converts the resolution of the rotated image data to 300×300 dpi.

In S812, the CPU 191 stores the image data in the external storage 199.

In S813, the CPU 191 determines whether the scanning process for all pages has been completed. If the CPU 191 determines that the scanning process has not been completed (No in S813), the CPU 191 returns to S805 and executes the scanning process of the next page. If the CPU 191 determines that the scanning process has been completed (Yes in S813), the CPU 191 proceeds to S814.

In S814, the CPU 191 and the image processing unit 190 convert the image data 903 stored in S812 according to the transmission format settings accepted in S801. In this embodiment, since the transmission format is not included in the scan instruction accepted from the extension application 204, the image data is converted to the default joint photographic experts group (JPEG) of the scanning device 102. However, the transmission format for conversion is not limited to this; any format that can be supported by the information processing apparatus is acceptable.

In S815, the converted image data is sent to the extension application 204, and this processing ends.

As has been described above, in this embodiment, the scan-settings-screen extension unit 205 of the extension application 204 corrects the scanning function information 203 based on the scanning functions from the general-purpose scanning software 202, the extension application 204, and the scanning device 102. When an advanced-settings screen is requested from the user, the scan-settings-screen extension unit 205 displays a settings screen based on the scan capability generated from the scanning function information 203, allowing the user to specify the document orientation. Then, upon receiving a scan instruction that reflects the specified document orientation, the scanning device 102 scans the document and performs a rotation process on the obtained image data according to the specified document orientation. Through the above series of processes, the scanning device 102 can implement the document-orientation setting function, allowing for providing the document-orientation setting function to the user.

Although this embodiment has been described using the advanced-settings screen illustrated in FIG. 3C with the configuration of FIG. 2B, the present disclosure is not limited to the embodiment. For example, when in S604 an advanced settings display request is provided to the general-purpose scanning software 202, the general-purpose scanning software 202 may display the advanced-settings screen illustrated in FIG. 3B. Next, after completion of the advanced settings in FIG. 3B, the general-purpose scanning software 202 requests the extension application 204 to display an additional advanced-settings screen. Next, the extension application 204 may additionally display an advanced-settings screen in which the document orientation can be specified.

Although the scan instruction to the extension application 204 is provided from the general-purpose scanning software 202, this is illustrative only. Other examples include a method in which the instruction is provided from the scanning application 201 to the extension application 204 and a configuration in which a control for a scan instruction is disposed on the advanced-settings screen so that the user can directly provide the instruction to the extension application 204. The image data may be directly passed from the extension application 204 to the scanning application 201 not via the general-purpose scanning software 202 or may be passed from the scanning device 102 to the scanning application 201. The received image data may be stored in the external storage 114, with only the file path information of the storage being passed along.

In this embodiment, when multiple pieces of image data are involved, all the image data is received and then passed along at once. Alternatively, transmitted image data may be passed along at any time.

### Second Embodiment

A second embodiment of the present disclosure will be described hereinbelow. In the first embodiment, a method is described for obtaining image data in which the top edge of the document at the top by specifying the orientation of the document placed on the scanning device 102.

In the second embodiment, a method will be described for obtaining image data by specifying the rotation angle of the document, rather than the orientation. Only the differences from the first embodiment will be described hereinbelow.

### Advanced-Settings Screen (Extension Application)

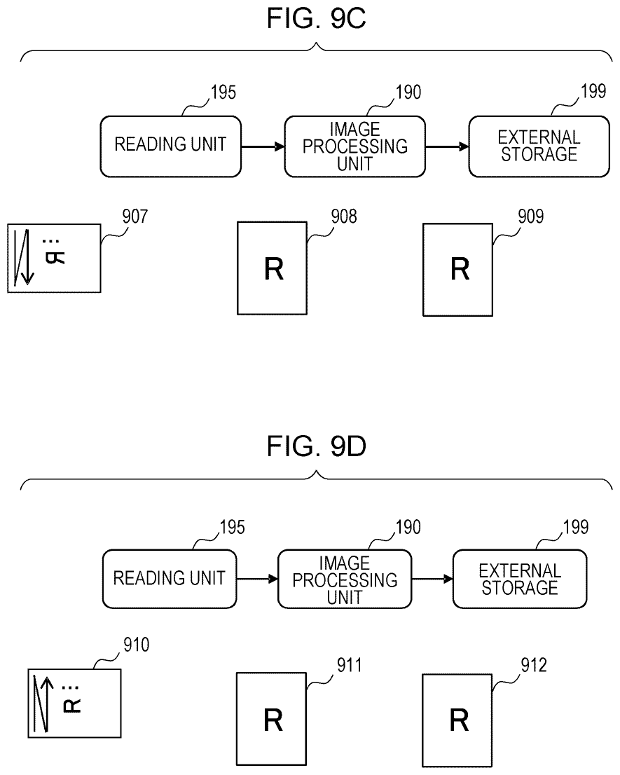

FIG. 10 illustrates an advanced-scan-settings screen displayed in the case of the configuration with the extension application 204, which corresponds to FIG. 3C in the first embodiment. The difference between FIG. 10 and FIG. 3C is that the rotation angle of the image, rather than the document orientation, is set with control 1001, and it can be configured to 0°, 90°, 180°, or 270°. By specifying the rotation angle, the user can obtain image data in a required orientation.

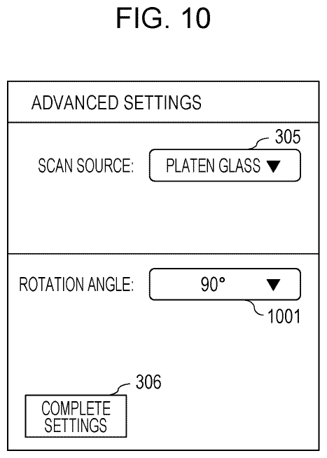

A list 1101 shown in FIG. 11 lists the scanning functions obtained from the scanning device 102. The difference from the list 501 in the first embodiment is that the rotation angle, rather than the document orientation, can be specified.

A list 1102 shown in FIG. 11 is a scanning function list supported by the extension application 204. The difference from the list 502 in the first embodiment is that the rotation angle, rather than the document orientation, can be specified similarly to the above description.

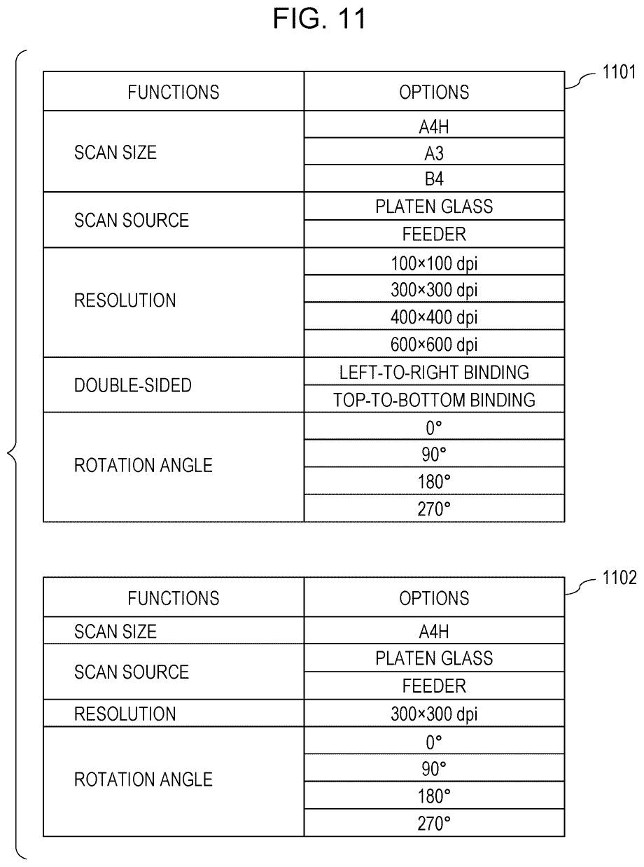

Next, the operation of the scanning device 102 when Scan source: Platen glass and Rotation angle: 90° are selected by the user, as shown in FIG. 10, will be described with reference to FIG. 12.

Reference sign 1201 in FIG. 12 denotes a document placed on the platen glass with the printed side facing downward.

The reversal of the letter R indicates that the printed side is facing downward. The document 1201 is scanned by the reading unit 195 as indicated by the arrow and is recorded in the RAM 193 as image data 1202. The image data 1202 obtained from the reading unit 195 is oriented to the left (in the 9 o'clock direction). As a result of the image processing unit 190 rotating the image data 1202 by 90°, as set by the control 1001, image data 1203 is obtained. The generated image data 1203 is finally sent to the extension application 204, and all the processes are completed.

In this embodiment, the rotation angle of the image is specified via the advanced-settings screen, as described above. This configuration allows an image-rotation-angle setting function to be provided to the user. The image-rotation-angle setting described in this embodiment may be configured simultaneously with the document-orientation setting function described in the first embodiment. If both of the settings are configured, the image data should be rotated by the sum of the rotation angle specified by the document orientation setting and the rotation angle specified by the rotation angle setting.

### Third Embodiment

In a third embodiment, a method will be described in which an image is rotated using the orientation of the letter on the document, rather than setting the document orientation or the rotation angle, to obtain image data.

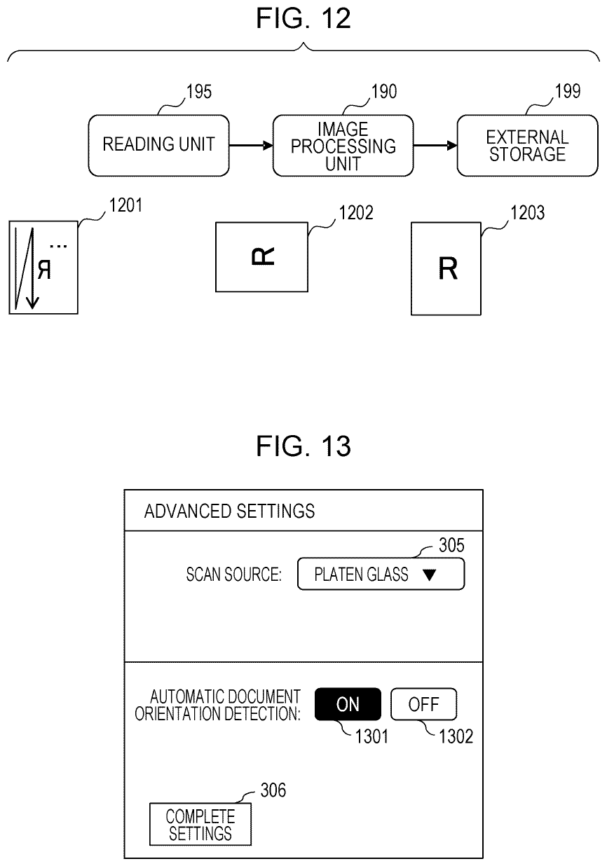

FIG. 13 illustrates an advanced-scan-settings screen displayed in the case of the configuration with the extension application 204, which corresponds to FIG. 3C in the first embodiment. The difference between FIG. 13 and FIG. 3C is that the document orientation is automatically detected, rather than set by a control 1301 or 1302. By setting the automatic document orientation detection to the control 1301, ON, the orientation of the document is automatically detected and rotated, and the user can obtain rotated image data.

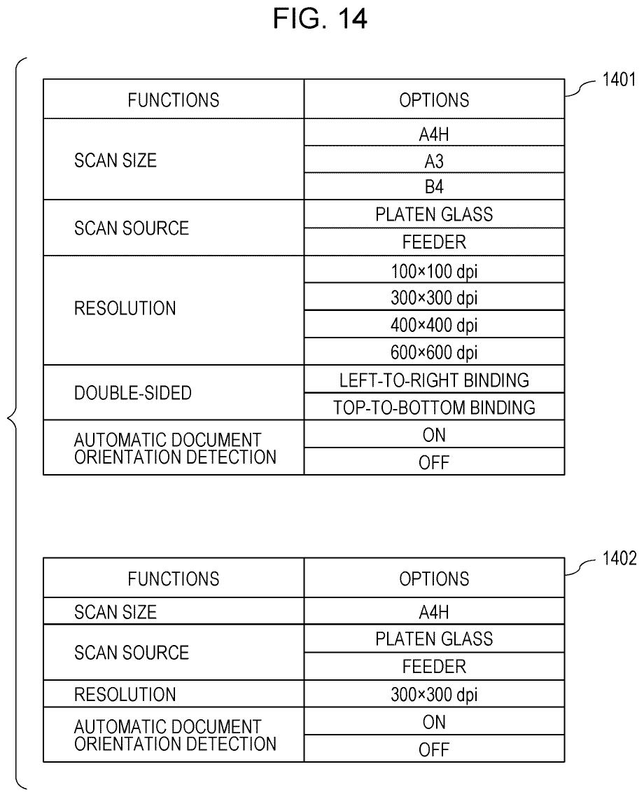

A list 1401 shown in FIG. 14 is a list of scanning functions obtained from the scanning device 102. The difference from the list 501 in the first embodiment is that automatic document orientation detection, rather than document orientation, can be configured. A list 1402 shown in FIG. 14 is a list of scanning functions supported by the extension application 204. The difference from the list 502 in the first embodiment is that automatic document orientation detection, rather than document orientation, can be configured.

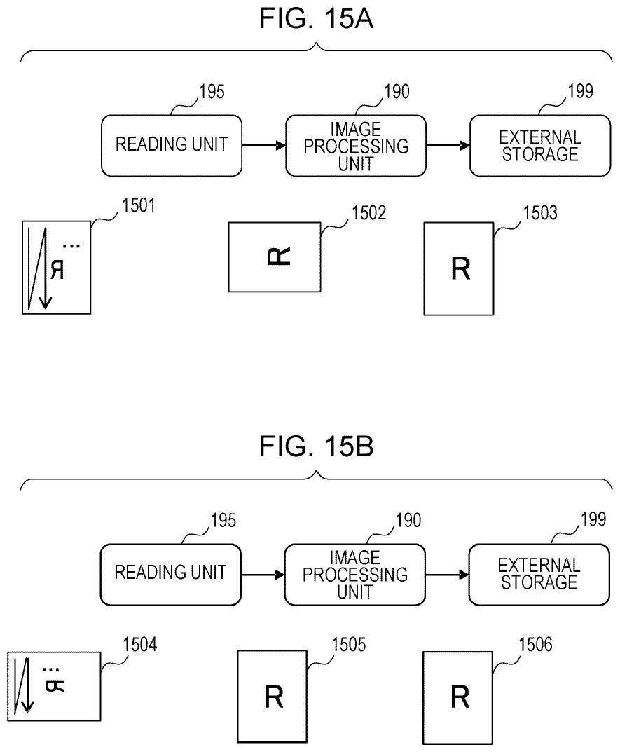

Next, the operation of the scanning device 102 when Scan source: Platen glass and Automatic document orientation detection: ON are selected, as shown in FIG. 13, will be described with reference to FIGS. 15A and 15B.

Reference sign 1501 in FIG. 15A denotes a document placed on the platen glass, with the printed side facing downward.

The reversal of the letter R indicates that the printed side is facing downward. The document 1501 is scanned by the reading unit 195 as indicated by the arrow and is recorded in the RAM 193 as image data 1502. The image data 1502 obtained from the reading unit 195 is oriented to the left (in the 9 o'clock direction). The image data 1502 is subjected to optical character recognition (OCR) by the image processing unit 190 to determine the document orientation. For example, if “R” on the image data 1502 is a letter on the document, the result of OCR indicates that the image data 1502 is oriented in the 9 o'clock direction. For this reason, to orient the image 1502 in the 0 o'clock direction, the image data 1502 should be rotated 90° to the right. In image data 1503 thus obtained, the letter “R” is oriented in the 0 o'clock direction.

Another example will be described with reference to FIG. 15B.

The operation when a document is placed on the platen glass, as in the case of a document 1504, will be described. The document 1504 is scanned by the reading unit 195 as indicated by the arrow and is recorded in the RAM 193 as image data 1505. The image data 1505 obtained from the reading unit 195 is oriented upward (in the 0 o'clock direction). The image data 1505 is subjected to optical character recognition (OCR) by the image processing unit 190 to determine the document orientation. In this example, the image data 1505 is already oriented in the 0 o'clock direction at the time of scanning, eliminating the need for rotation by the image processing unit 190, and therefore, only another image processing (resolution conversion to 300×300 dpi as in the first embodiment) is performed to obtain image data 1506.

The generated image data 1503 and 1506 are finally sent to the extension application 204, and all the processes are completed.

In this embodiment, by enabling the automatic document orientation detection via the advanced-settings screen, as described above, a function to automatically rotate the image to the correct orientation, regardless of how the document placed can be provided to the user.

### Fourth Embodiment

A fourth embodiment of the present disclosure will be described hereinbelow.

In a fourth embodiment, a method for obtaining image data will be described in which a preview image is displayed, from which the orientation of image data obtained from the scanner is checked, and an appropriate rotation angle is specified by the user.

Only the differences from the first embodiment will be described hereinbelow.

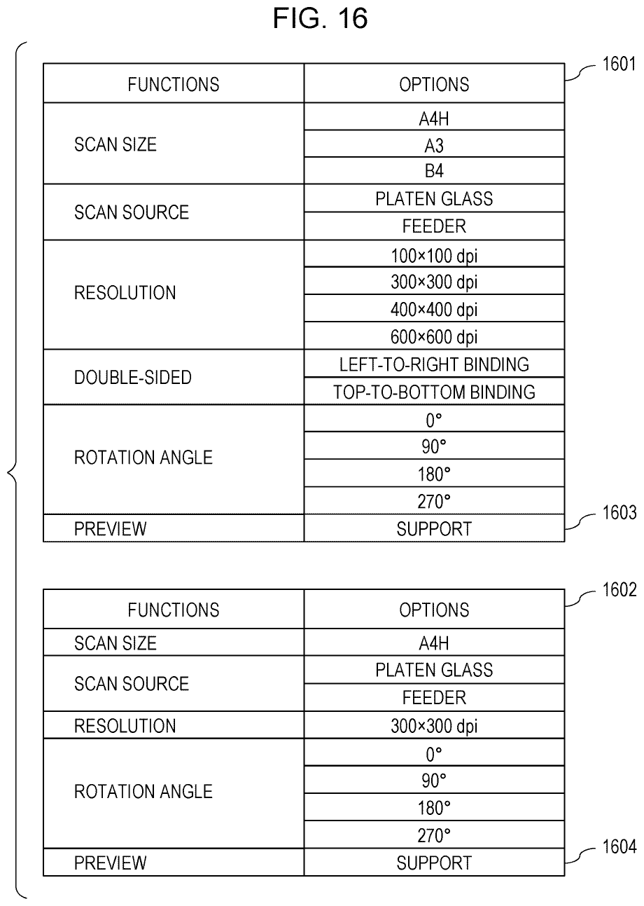

FIG. 16 shows lists 1601 and 1602. The list 1601 is an example of scanning functions obtained from the scanning device 102 in this embodiment. As shown in the list 1601, Preview: Support 1603 information is obtained from the scanning device 102. For the extension application 204 as well, Preview: Support information 1604 is configured as shown in the list 1602.

### Advanced-Settings Screen (Extension Application)

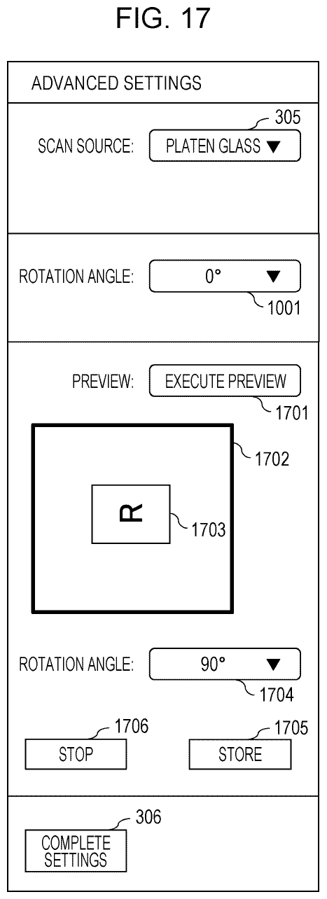

FIG. 17 illustrates an example of an advanced-settings screen in which the preview function is available. FIG. 17 illustrates an area 1702 in which a preview image is displayed and a control 1701 that prompts execution of preview.

A preview image 1703 obtained from the scanner is previewed in the area 1702. A control 1704 is used to specify a rotation angle applied to the displayed preview image while in the preview state, which will be described later. This differs from the control 1001, which is used to set the image rotation angle as described in the second embodiment. Options include 0°, 90°, 180°, and 270°. A control 1705 is used to issue an instruction to store the preview image, the details of which will be described later. A control 1706 is used to stop the image rotation process using the preview image.

### Sequence of Scanning Process

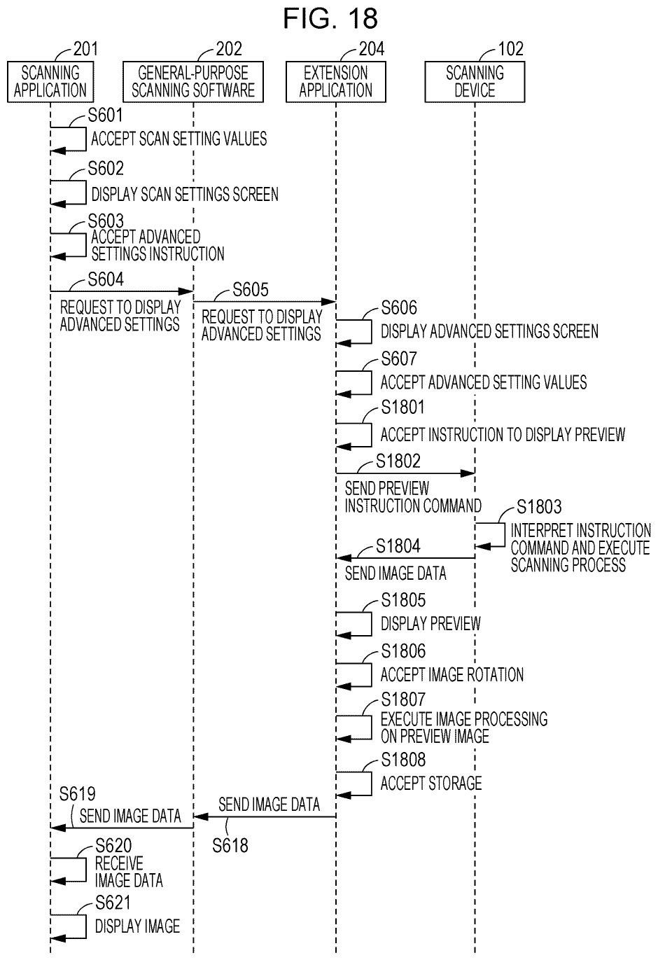

Referring to FIG. 18, the sequence of a scanning process performed by the scanning application 201, the general-purpose scanning software 202, the extension application 204, and the scanning device 102 after accepting scan setting values will be described. The steps other than those of the scanning device 102 in FIG. 18 are performed by the CPU 111 reading the scanning application 201, the general-purpose scanning software 202, and the extension application 204 from the external storage 114 into the RAM 113 and executing them. The steps of the scanning device 102 in FIG. 18 are implemented by the CPU 191 of the scanning device 102 reading the programs that are stored in the ROM 192 or the external storage 199 into the RAM 193 and executing them. The following description omits the steps identical to those in the sequence shown in FIG. 6, and describes only the differences hereinbelow.

In S1801, the extension application 204 accepts an instruction to display a preview. The user can issue the instruction to display a preview by selecting the control 1701 with the pointing device 117 or the keyboard 118.

In S1802, the extension application 204 sends the preview instruction command to the scanning device 102 and issues a scan instruction for the preview. For the scan instruction, a scan instruction command based on the setting values accepted at that time is created.

In S1803, the scanning device 102 interprets the received preview instruction command and executes a scanning process.

Next, in S1804, the scanning device 102 sends generated image data to the extension application 204.

In S1805, the extension application 204 displays the received preview image 1703 in the area 1702. The preview image 1703 is an example in which the top edge of the image is facing leftward (in the 9 o'clock direction).

In S1806, the extension application 204 accepts a user instruction to rotate the image via the pointing device 117 or the keyboard 118 through the control 1704. Here, the user issues an instruction to rotate the image from the 9 o'clock direction to the 0 o'clock direction by 90°.

In S1807, the extension application 204 performs image rotation on the

preview image received from the scanning device 102 in S1804 using the image-data editing unit 207.

In S1808, the extension application 204 accepts an instruction to store the preview image. The user can issue the instruction to store the preview image by selecting the control 1705 by operating the pointing device 117 or the keyboard 118. In response to the instruction for storage, the extension application 204 passes the image data to the general-purpose scanning software 202. The general-purpose scanning software 202 passes the image data to the scanning application 201, enabling the scanning application 201 to process the image data.

### Scanning Process (Extension Application)

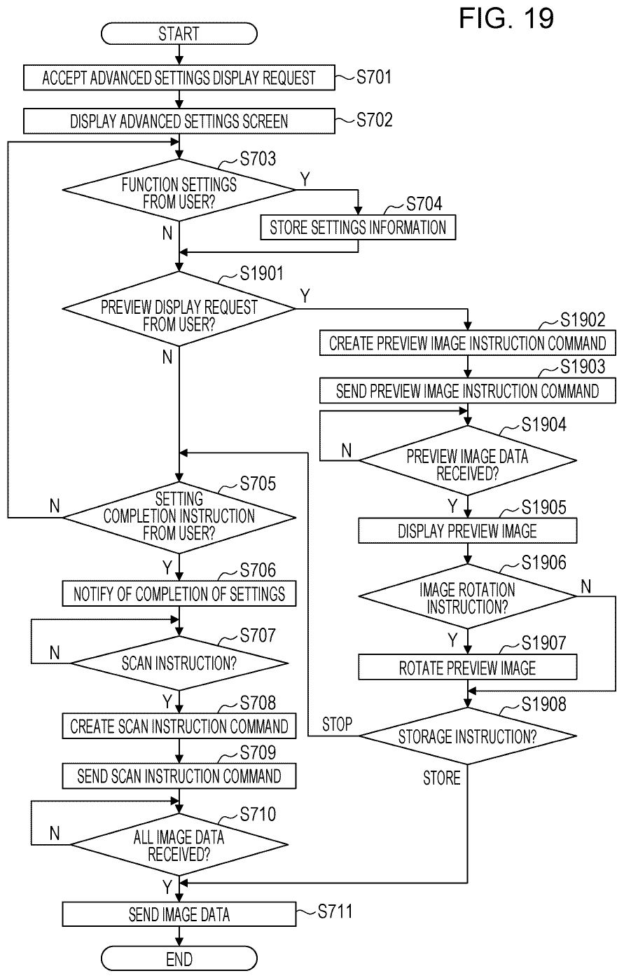

Here, the procedure of the scanning process executed by the extension application 204 will be described with reference to FIG. 19. The steps are implemented by the CPU 111 executing the units read from the external storage 114 into the RAM 113. Descriptions of the steps identical to those of FIG. 7 will be omitted, and only the differences will be described.

In S1901, the scan-settings-screen extension unit 205 determines whether a preview display request has been provided by the user. If a preview display request has been provided (Yes in S1901), the process proceeds to S1902; otherwise (No in S1901), the process proceeds to S705.

In S1902, the extension application 204 creates a preview image instruction command based on the settings information stored in S704.

A method for creating the preview image instruction command in S1902 is to extend a standard protocol command is extended similarly to the scan instruction command. Examples of extension methods include writing a dedicated command in the extended area of a standard protocol command, adding a proprietary protocol command to the tail end of a standard protocol command, and overwriting a standard protocol command with a proprietary command system by the extension application 204.

If instructions are provided from the extension application 204, the instructions and communication may be carried out using a vendor's proprietary protocol without reference to the standard protocol.

In S1903, the extension application 204 sends the preview image instruction command to the scanning device 102 to execute scanning.

In S1904, the extension application 204 determines whether all preview image data has been received from the scanning device 102. If all preview image data has been received (Yes in S1904), the process proceeds to S1905; otherwise (No in S1904), the process returns to S1904, where it is determined whether preview image data has been received from the scanning device 102.

In S1905, the extension application 204 displays the received preview image data.

In S1906, it is determined whether an instruction to rotate the image has been received from the user via the control 1704. If an instruction to rotate the image has been received (Yes in S1906), the process proceeds to S1907; otherwise (No in S1906), the process proceeds to S1908.

In S1907, the preview image received from the scanning device 102 is rotated by the image-data editing unit 207.

In S1908, the scan-settings-screen extension unit 205 determines whether a request to store the preview image has been given from the user. If a storage instruction (“Store” in S1908) has been given via the control 1705, the process proceeds to S711. If a stop instruction (“Stop” in S1908) has been given via the control 1706, the process proceeds to S705.

In the fourth embodiment, a preview image is displayed using the extension application 204, as described above. By changing the preview image according to the setting, an image rotating function can be provided so that the user can easily image the resultant image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-077775, filed May 13, 2024, which is hereby incorporated by reference herein in its entirety.

What is claimed is:

1. A non-transitory computer-readable storage medium storing a program for supporting general-purpose scanning software that is commonly available for use with image processing devices provided by a plurality of manufacturers, the program causing a computer of an information processing apparatus to execute a method comprising:
displaying a display screen that accepts a document orientation setting value on a display unit; and
issuing a scan instruction to an image processing device based on the setting value accepted on the display screen.

2. The non-transitory computer-readable storage medium according to claim 1, wherein, when the scan instruction is issued to the image processing device, a command is created by extending a standard protocol command.

3. The non-transitory computer-readable storage medium according to claim 1, wherein, when the scan instruction is issued to the image processing device, a proprietary command is added to a standard protocol command and transmitted to the image processing device.

4. The non-transitory computer-readable storage medium according to claim 1, wherein, when the scan instruction is issued to the image processing device that executes the scan, a proprietary command is transmitted to the image processing device instead of a standard protocol command.

5. The non-transitory computer-readable storage medium according to claim 1, wherein the display screen is generated based on a scanning function obtained from the image processing device.

6. A control method for an information processing apparatus including a program for supporting general-purpose scanning software that is commonly available for use with image processing devices provided by a plurality of manufacturers, the control method comprising:
displaying a display screen that accepts a document orientation setting value on a display unit by executing an application program that supports the program; and
issuing a scan instruction to an image processing device based on the setting value accepted on the display screen.

7. An information processing apparatus including a program for supporting general-purpose scanning software that is commonly available for use with image processing devices provided by a plurality of manufacturer, the apparatus comprising:
at least one memory storing an application program that supports the program; and
at least one processor that executes the stored application program, which causes the at least one processor to:
perform display on a display screen that accepts a document orientation setting value on a display unit; and
issue a scan instruction to an image processing device based on the setting value accepted on the display screen.
